(19) United States
(12) Patent Application Publication
(10) Pub. No.: US 2009/0084629 A1
(43) Pub. Date: Apr. 2, 2009

(54) Intermediate Bracket

(76) Inventor: Simon Luke, Solihull (GB)

Correspondence Address: Ira S Dorman, 330 Roberts Street, Suite 200, East Hartford, CT, 06108, US

(21) Appl. No.: 11/992,269

(22) PCT Filed: Sep. 15, 2006
(86) PCT No.: PCT/GB2006/003433

§ 371 Date: Mar. 19, 2008

(30) Foreign Application Priority Data
Sep. 23, 2005 (GB) 0519403.0

(51) Int. Cl. A62B 1/04

(52) U.S. Cl. 182/129

(57) ABSTRACT

An intermediate bracket for a fall arrest system mounted on a structure comprises a securing member (1) adapted to be secured to the structure. An attachment arm (3) is pivotably attached at a first end to the securing member and a cable fixing member (5) is pivotably attached to a second end of the attachment arm and adapted to support a safety cable of the fall arrest system at a distance from the structure.

This invention relates to an intermediate bracket for a fall arrest system, for example for use with a safety cable of a fall arrest system attached to a structure such as a pylon and used in conjunction with a fall arrest device.

To ensure the safety of a person (user) climbing a structure, for example an electricity pylon, a safety system is used in which the person is attached to a safety cable by way of a fall arrest device which is movable along the cable. The safety cable runs along the structure, for example up one corner of the pylon from a position approximately 3 metres from the ground to the top of the pylon.

Intermediate brackets are provided at intervals along the structure forming intermediate positions where the safety cable is attached to the structure. The intermediate brackets and the fall arrest device must be configured to allow the fall arrest device to pass over the intermediate brackets.

It is often necessary to be able to provide intermediate brackets which extend to differing distances from the structure. For example, in the case of an electricity pylon, the taper angle of the pylon can change with the height of the pylon, for example being greater near the base than at the top. Also, portions of the structure of the pylon can extend outwards from the corners of the pylon. It is necessary to be able to vary the distance between a cable fixing portion of the intermediate bracket holding the safety cable and the pylon to enable the cable to be positioned at a predetermined distance from the pylon so as to compensate for the varying taper angle and any extending portions of the pylon's structure.

Known intermediate brackets have fixed distances between the cable fixing portion and the body of the bracket. Consequently, a number of different intermediate brackets with differing distances between the cable fixing portion and the body of the bracket must be used. Prior to positioning a safety cable on a structure such as a pylon, the various different intermediate brackets must first be threaded onto the safety cable and/or fitted to the structure in the order required to correspond to predetermined positions on the pylon. If, in securing the brackets to the pylon, it becomes apparent that the order of brackets is wrong, the intermediate brackets have to be removed from the safety cable or structure and replaced in the correct order.

There is a need for an adjustable intermediate bracket that enables a user, in situ, to compensate for changing taper angle or extending portions of a structure such as a pylon. It is therefore an object of the present invention to provide an intermediate bracket which overcomes or minimises these problems.

According to the present invention there is provided an intermediate bracket for a fall arrest system mounted on a structure, the intermediate bracket comprising a securing member adapted to be secured to the structure, an attachment arm pivotably attached at a first end to the securing member and a cable fixing member pivotably attached to a second end of the attachment arm and adapted to support a safety cable of the fall arrest system at a distance from the structure.

Thus, the intermediate bracket is adjustable and it is no longer important to thread the intermediate brackets onto the safety cable or prefix the intermediate brackets to the structure in a specific order.

The securing member may have a dish-like form comprising a base and a peripheral wall.

An elongate slot may be provided through the securing member for connecting the securing member to the structure.

The securing member may comprise two portions separated by an intermediate wall.

Retaining means, for example a shoulder, may be provided on the securing member and adapted to assist in securing the securing member in a predetermined position relative to the structure.

The attachment arm may have a dish-like form comprising a base and a peripheral wall.

Detents may be provided to limit pivotal movement of the attachment arm relative to the securing member. The detents may be formed at opposing ends of an arcuate groove provided in one end of the attachment arm. Relative movement between the attachment arm and the securing member may be limited, for example, to 40 degrees.

The cable fixing member may comprise a cylindrical body, adapted to receive the safety cable therethrough, and a support member. Preferably the support member is “L” shaped.

Isolating material, adapted to minimise galvanic reaction, may be provided between the securing member and the attachment arm and/or between the attachment arm and the cable fixing member and/or between the securing member and the structure. The isolating material may be a plastics material, for example a hardwearing plastics material.

Locking means may be provided on opposing faces of the attachment arm and the securing member to lock the attachment arm in a number of different angular configurations relative to the securing member. The locking means may comprise a multi-edged projection on one of the opposing faces, the projection being adapted to engage with a corresponding multi-edged projection provided in the other opposing face.

A structure incorporating a bracket as described hereinbefore may have the attachment arm secured at a downward angle relative to the securing member. The downward angle deters users from standing on the attachment arm during use of the fall arrest system.

For a better understanding of the present invention and to show more clearly how it may be carried into effect reference will now be made, by way of example, to the accompanying drawings in which:

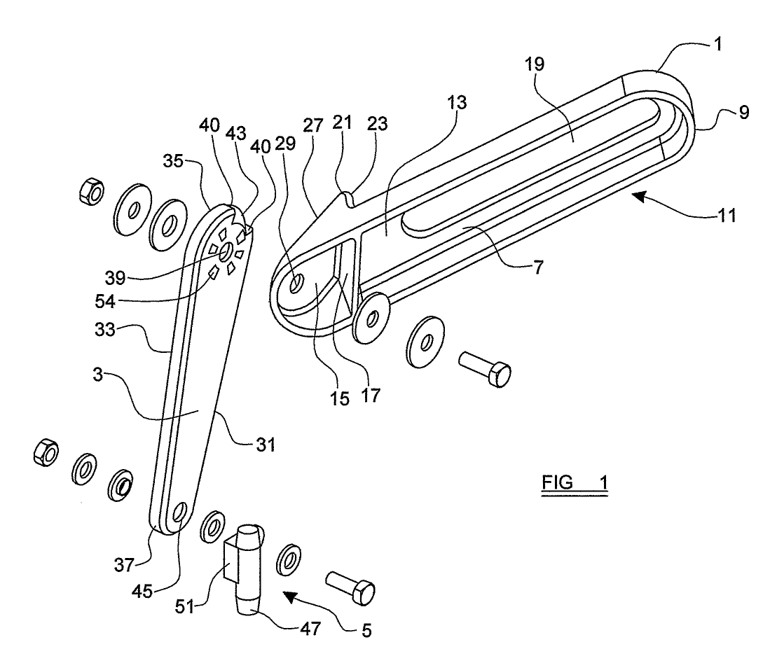

FIG. 1 is an exploded perspective view of an embodiment of an intermediate bracket according to the present invention;

FIG. 2 is a plan view of the intermediate bracket shown in FIG. 1; and

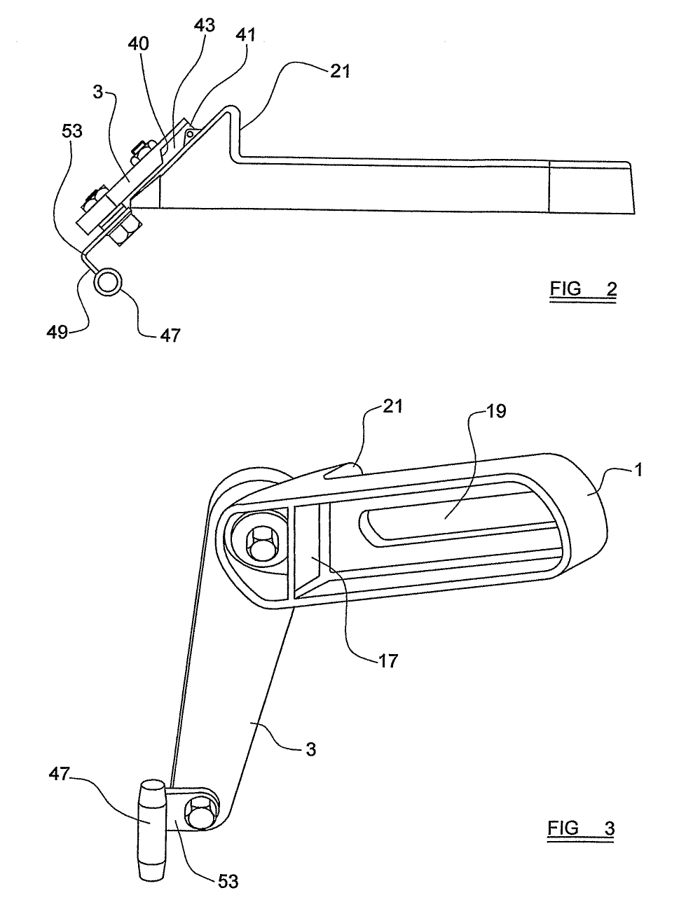

FIG. 3 is a perspective view of the intermediate bracket shown in FIG. 1.

The figures show an intermediate bracket according to the present invention for use on a structure, for example an electricity pylon. The intermediate bracket forms part of a fall arrest system and comprises a securing member 1, an elongate attachment arm 3 and a cable fixing member 5.

The securing member 1, preferably of cast aluminium alloy, has a dish-like form with a base 7 and a peripheral wall 9 extending from the base to form an open face 11. The arrangement of a base and a peripheral wall provides a component of relatively high strength and rigidity, but of relatively low weight. The securing member 1 comprises a first portion 13 and a second portion 15 separated by an intermediate strengthening wall 17.

The first portion 13 of the securing member 1 has a substantially planar face forming a portion of the base 7 of the securing member 1. An elongate slot 19 is provided through the face of the first portion 13 of the securing member 1 to enable the securing member to be attached to the structure, such as to step bolts (not shown) provided on a pylon.

The intermediate wall between the first portion 13 and the second portion 15 of the securing member 1 has a region 21 extending outwardly from the plane of the face of the first portion 13 of the securing member 1 and away from the open face of the securing member 1. The region 21 of the intermediate wall forms a first face 23 of the second portion 15 of the securing member 1. The angle subtended between the face of the first portion 13 and an exterior surface of the first face 23 of the second portion 15 is substantially 90 degrees.

The subtended angle between the face of the first portion 13 and the exterior surface of the first face 23 gives rise to a shoulder which, in use, abuts against the corner of a girder of a pylon.

A second face 27 of the second portion 15 of the securing member 1 extends between an end of the region 21 of the intermediate wall, furthest from the open face 11 of the securing member 1, and a forward region of the open face. Because the region 21 extends outwardly from the plane of the first portion 13 and the second face 27 extends back towards the forward region of the open face 11, the second face 27 is inclined relative to the plane of the open face of the securing member leading to an increase in a depth of the second portion from the forward region of the open face of the securing member to the intermediate wall 17.

A hole 29 is provided through the second face 27 of the second portion 15 of the securing member 1 to enable the attachment arm 3, as described hereinafter, to be attached to the securing member 1.

The attachment arm 3 is an elongate dish-like body having a face 31 and a peripheral wall 33 extending therefrom so as to increase the strength and rigidity of the component without significantly increasing the weight thereof. The attachment arm 3 has a first outwardly arcuate end 35 and a second outwardly arcuate end 37. The attachment arm 3 narrows from the first end 35 towards the second end 37.

A first through hole 39 is provided through the face of the attachment arm 3 in the region of the first end thereof.

The attachment arm 3 is positioned such that an exterior surface of the face 31 of the arm, in the region of the first end 35 thereof, is in contact with an exterior surface of the second face 27 of the second portion 15 of the securing member 1.

The attachment arm 3 is secured in place relative to the securing member 1 by fastening means, for example a bolt and fastening nut. The fastening means acts as a pivot axis about which the attachment arm 3 can be pivoted relative to the securing member 1.

The extent to which the attachment arm 3 can be pivoted relative to the securing member 1 is limited by a pair of detents 40 (shown in FIG. 1) provided on the first end of the attachment arm 3 and a projection 41 (shown in FIG. 2) on the exterior surface of the second face 27 of the securing member 1. The detents 40 are in practice either end of an outwardly arcuate groove 43 in the exterior face 31 of the first end of the attachment arm 3. The projection 41 is positioned within the groove 43. The length of the groove 43 permits the attachment arm 3 to be rotated through a predetermined angle, for example 40 degrees, before further rotational movement in either direction is prevented by the projection 41 coming into contact with the detents 40.

In practice, the attachment arm 3 is generally angled downwardly relative to the securing member 1, rather than upwardly, to deter users from standing on the attachment arm 3 during use of the fall arrest system and to persuade users to stand on the structure itself, such as on step bolts provided on a pylon.

A second through hole 45 is provided through the face of the attachment arm 3 in the region of the second end 37 thereof to enable the cable fixing member 5 as referred to hereinbefore to be attached to the attachment arm 3.

The cable fixing member 5 comprises a cylindrical tubular element 47 attached to a first arm 49 of an “L” shaped support member 51 (see FIG. 2). A through hole (not shown) is provided in a second arm 53 of the support member 51. The cable fixing member 5 is pivotably attached to the attachment arm 3 by a fastening means, for example a bolt and fastening nut, passing through the hole in the second arm of the support member and through the second through hole 45 in the attachment arm 3.

The lengths of the first arm 49 and the second arm 53 of the support member 51 are selected such that a securing means attaching a user to the safety cable can readily be passed between the cylindrical element 47 and the attachment arm 3.

Pylons are generally galvanised and painted to avoid galvanic corrosion problems. In order further to reduce the risk of corrosion, the intermediate bracket is isolated from the pylon by means of isolating washers provided between the cable fixing member 5 and the attachment arm 3, and between the attachment arm 3 and the securing member 1, and between the securing member 1 and the pylon, to minimise the possibility of a galvanic reaction between the pylon and the intermediate bracket. The isolating washers are made of DELRIN, an insulating Nylon-type polymer which is hardwearing and resistant to UV degradation, or an equivalent material.

In use, a number of intermediate brackets in accordance with the present invention are threaded onto a safety cable of a fall arrest system such that the cable passes through the cylindrical element 47 of the cable fixing member 5 of each intermediate bracket. Each intermediate bracket is then attached to the structure, for example to a region of a corner of a pylon, by passing a step bolt, which is conventionally provided on the pylon to enable a worker to climb the pylon, through the elongate slot 19 in the securing member 1 and fastening the bracket in place with a fastening nut. It is not permissible to drill fixing holes through the girders of the pylon as this could affect the structural strength of the pylon. Clearly the intermediate brackets can be attached to the structure if desired by providing alternative fastening means which is adapted to pass through the elongate slot 19 and fastening the bracket to the structure.

The elongate slot 19 enables the intermediate bracket to be positioned such that the corner of a girder of the pylon abuts the shoulder of the securing member 1, so ensuring that the brackets are always positioned in the same relative position to the pylon irrespective of the dimensions of pylon girder.

The distance between the safety cable and the structure, such as the corner of a pylon, can be adjusted, for example from substantially 70 mm to substantially 185 mm, to compensate for variations in the structure, such as the varying taper of a pylon, and to avoid any protruding portions of the structure by pivoting the attachment arm 3, and thus the cable fixing member, relative to the securing member 1 to move the cable fixing member 5 either towards or away from the structure.

It is also possible with an intermediate bracket in accordance with the present invention to align the cable substantially parallel to a vertical plane passing from the top of a structure, for example a pylon, to the ground by pivoting the cable fixing member 5 relative to the attachment arm 3.

Consequently, pivotal movement between the attachment arm, the securing member and the cable fixing member permits the intermediate brackets to be manipulated in situ to compensate for the features of a particular region of a structure such as a pylon. Once the predetermined orientation of the securing member, attachment arm and cable fixing member has been achieved, the relative positions are retained by additional tightening of the fastening means as described hereinbefore.

Additional means is provided for locking the orientation of the securing member 1 relative to the attachment arm 3. A regular multi-edged projection 54, for example a star-shaped or octagonal projection, is provided on the exterior surface of the second face 27 of the securing member. The projection is positioned in use to engage with a corresponding multi-edged projection 54 in the exterior surface of the face 31 of the attachment arm, thereby locking together the attachment arm and the securing member.

To change the orientation of the securing member 1 relative to the attachment arm 3, the fastening means is loosened such that the opposing faces of the securing member and the attachment arm are separated and the multi-edged projections 54 are released from each other. Subsequently, the attachment arm is rotated to a second orientation relative to the securing arm about the fastening means (which acts as a pivot axis). Tightening of the fastening means draws together the opposing faces of the securing arm and the attachment member, thus re-engaging the multi-edged projections 54 and re-locking the orientation of the securing member relative to the attachment arm.

Once positioned on a structure, such as a pylon, the intermediate brackets are arranged such that a subsequent user can manoeuvre around the structure, for example climb up the corner of a pylon, without undue impedance by the intermediate brackets, any protruding portions of the structure or the orientation of the safety cable.

1. An intermediate bracket for a fall arrest system mounted on a structure, the intermediate bracket comprising a securing member (1) adapted to be secured to the structure, an attachment arm (3) pivotably attached at a first end to the securing member, and a cable fixing member (5) comprising a cylindrical body (47) adapted to receive a safety cable of the fall arrest system therethrough and a support member (51) pivotably attached to a second end of the attachment arm and adapted to support a safety cable of the fall arrest system at a distance from the structure.

2. An intermediate bracket as claimed in claim 1, wherein the securing member (1) has a dish-like form comprising a base (7) and a peripheral wall (9).

3. An intermediate bracket as claimed in claim 1, wherein an elongate slot (19) is provided through the securing member (1) for connecting the securing member to the structure.

4. An intermediate bracket as claimed in claim 1, wherein the securing member (1) comprises two portions (13, 15) separated by an intermediate wall (17).

5. An intermediate bracket as claimed in claim 1, wherein retaining means (23) is provided on the securing member (1) and adapted to assist in securing the securing member in a predetermined position relative to the structure.

6. An intermediate bracket as claimed in claim 5, wherein the retaining means comprises a shoulder (23) provided on the securing member (1).

7. An intermediate bracket as claimed in claim 1, wherein the attachment arm (3) has a dish-like form comprising a base (31) and a peripheral wall (33).

8. An intermediate bracket as claimed in claim 1, wherein detents (40) are provided to limit pivotal movement of the attachment arm (3) relative to the securing member (1).

9. An intermediate bracket as claimed in claim 8, wherein the detents (40) are formed at opposing ends of an arcuate groove (43) provided in one end of the attachment arm (3).

10. An intermediate bracket as claimed in claim 8, wherein relative movement between the attachment arm (3) and the securing member (1) is limited to 40 degrees.

11. (canceled)

12. An intermediate bracket as claimed in claim 1, wherein the support member (51) is “L” shaped.

13. An intermediate bracket as claimed in claim 1, wherein isolating material, adapted to minimise galvanic reaction, is provided between the securing member (1) and the attachment arm (3).

14. An intermediate bracket as claimed in claim 1, wherein isolating material, adapted to minimise galvanic reaction, is provided between the attachment arm (3) and the cable fixing member (5).

15. An intermediate bracket as claimed in claim 1, wherein isolating material, adapted to minimise galvanic reaction, is provided between the securing member (1) and the structure.

16. (canceled)

17. (canceled)

18. An intermediate bracket as claimed in claim 1, wherein locking means (54) is provided on opposing faces (27, 31) of the attachment arm (3) and the securing member (1) to lock the attachment arm in a number of different angular configurations relative to the securing member.

19. An intermediate bracket as claimed in claim 18, wherein the locking means (54) comprises a multi-edged projection on one of the opposing faces (27, 31), the projection being adapted to engage with a corresponding multi-edged projection provided in the other opposing face.
